(19) United States
(12) Patent Application Publication
(10) Pub. No.: US 2026/0339471 A1
(43) Pub. Date: Oct. 29, 2026

(54) TOUCH DISPLAY PANEL AND TOUCH DISPLAY DEVICE

(71) Applicants: Chengdu BOE Optoelectronics Technology Co., Ltd., Sichuan Province (CN); BOE Technology Group Co., Ltd., Beijing (CN)

(72) Inventors: Shun ZHANG, Beijing (CN); Yudiao CHENG, Beijing (CN); Fengli JI, Beijing (CN); Chunyan LI, Beijing (CN)

(21) Appl. No.: 18/840,556

(22) PCT Filed: Nov. 28, 2023
(86) PCT No.: PCT/CN2023/134716

§ 371 Date: Aug. 22, 2024

(51) Int. Cl. G06F 3/044; G06F 3/041

(52) U.S. Cl. CPC G06F 3/0446; G06F 3/04164; G06F 3/0448; G06F 2203/04107; G06F 2203/04111; G06F 2203/04112

(57) ABSTRACT

A touch display panel and a touch display device. The touch display panel includes: a substrate; a shielding structure on one side of the substrate, located in the first region and surrounding the via-hole, where an orthographic projection of the shielding structure on the substrate extends from the display region toward the via-hole, and covers at least part of the first region; and a touch structure layer, located on the same side of the substrate as the shielding structure, where the touch structure layer includes: a first touch pattern and a second touch pattern, where the first touch pattern is disposed in the display region and the second touch pattern is disposed in the first region; and the first touch pattern and the second touch pattern are both a mesh structure including a plurality of first openings.

### TECHNICAL FIELD

The present disclosure relates to the field of semiconductor technology, and in particular to a touch display panel and a touch display device.

### BACKGROUND

In a touch panel, touch position detection is achieved by arranging transmitting (Tx) electrodes and receiving (Rx) electrodes crosswise on the panel in mutually orthogonal directions. In the electrode arrangement scheme proposed by a Flexible Multiple Layer on Cell (FMLOC) technology, driving electrodes and sensing electrodes are arranged in the same layer. The driving electrodes and sensing electrodes form touch cell patterns, and a touch position is determined by changing electrical parameters.

### SUMMARY

Embodiments of the present disclosure provide a touch display panel and a touch display device. The touch display panel has a via-hole penetrating through the touch display panel, a display region outside the via-hole, and a first region between the via-hole and the display region. The touch display panel includes: a substrate; a shielding structure on one side of the substrate, located in the first region and surrounding a periphery of the via-hole, where an orthographic projection of the shielding structure on the substrate; and a touch structure layer on a same side of the substrate as the shielding structure; where the touch structure layer includes: a first touch pattern and a second touch pattern; where the first touch pattern is disposed in the display region, and the second touch pattern is disposed in the first region; where the first touch pattern and the second touch pattern are both a mesh structure including a plurality of first openings.

In a possible implementation mode, the display panel further includes: a light-filtering structure layer; the light-filtering structure layer includes: a first shielding portion in the first region; and the shielding structure includes the first shielding portion.

In a possible implementation mode, the light-filtering structure layer is disposed on one side, facing away from the substrate, of the touch structure layer.

In a possible implementation mode, the touch display panel further includes: a pixel defining layer; the pixel defining layer includes: a second shielding portion in the first region; and the shielding structure includes the second shielding portion.

In a possible implementation mode, the touch display panel further includes: an active layer between the substrate and the touch structure layer, and a first light-shielding layer between the active layer and the substrate. The first light-shielding layer includes: a third shielding portion in the first region; and the shielding structure includes the third light-shielding portion.

In a possible implementation mode, the active layer includes a plurality of active portions in the display region. The first light-shielding layer includes: a plurality of fourth light-shielding portions in the display region. An orthographic projection of the fourth shielding portion on the substrate covers an orthographic projection of the active portion on the substrate.

In a possible implementation mode, the first light-shielding layer further includes: a plurality of connection structures in the display region. The plurality of fourth shielding portions are electrically connected through the plurality of connection structures. The plurality of fourth shielding portions, and the plurality of connection structures form a mesh structure having a plurality of second openings.

In a possible implementation mode, the touch display panel further includes: a dam structure and a first isolation structure between the substrate and the touch structure layer. The dam structure is disposed in the first region and surrounds the via-hole; and the first isolation structure is disposed between the dam structure and the via-hole and surrounds the via-hole. An orthographic projection of the second touch pattern on the substrate is at one side, facing away from the via-hole, of an orthographic projection of the dam structure on the substrate.

In a possible implementation mode, the touch display panel further includes: a dam structure, a first isolation structure and a first filling layer covering at least the first isolation structure, between the substrate and the touch structure layer. The dam structure is disposed in the first region and surrounds the via-hole; and the first isolation structure is disposed between the dam structure and the via-hole, and surrounds the via-hole. An orthographic projection of the second touch pattern on the substrate covers orthographic projections of the dam structure and at least a portion of the first isolation structure on the substrate.

In a possible implementation mode, the touch structure layer further includes: an anti-static structure. The orthographic projection of the second touch pattern on the substrate is at one side, facing away from the via-hole, of an orthographic projection of the anti-static structure on the substrate.

In a possible implementation mode, the orthographic projection of the anti-static structure is at one side, close to the via-hole, of an orthographic projection of the dam structure on the substrate.

In a possible implementation mode, the anti-static structure includes: a plurality of arc segments spaced apart from each other and surrounding the via-hole.

In a possible implementation mode, the touch structure layer includes: a plurality of first touch electrodes extending along a first direction, and a plurality of second touch electrodes extending along a second direction. The first touch electrode includes a plurality of first touch electrode blocks sequentially arranged along the first direction and electrically connected, and the second touch electrode includes a plurality of second touch electrode blocks sequentially arranged along the second direction and electrically connected. One of the first touch electrode block and the second touch electrode block includes a third touch electrode block, and the via-hole is disposed in the third touch electrode block. The third touch electrode block includes the second touch pattern.

In a possible implementation mode, the third touch electrode block has a first hollow portion; and an orthographic projection of the first hollow portion on the substrate covers an orthographic projection of the via-hole on the substrate.

In a possible implementation mode, the touch structure layer includes: a plurality of first touch electrodes extending in a first direction, and a plurality of second touch electrodes extending in a second direction. The first touch electrode includes a plurality of first touch electrode blocks sequentially arranged along the first direction and electrically connected, and the second touch electrode includes a plurality of second touch electrode blocks sequentially arranged along the second direction and electrically connected. At least one of the second touch electrodes is divided by the via-hole into a first sub-touch electrode and a second sub-touch electrode which are discontinuous. The touch structure layer further includes: a connection structure; where the connection structure is disposed in the first region, surrounds the via-hole, and is electrically connected to the first sub-touch electrode and the second sub-touch electrode on both sides of the via-hole. The second touch pattern is disposed on one side of the connection structure close to the via-hole, and is electrically connected to the connection structure.

In a possible implementation mode, the second touch pattern is a ring shape surrounding the via-hole.

In a possible implementation mode, the touch structure layer further includes: a plurality of first compensation structures at one side of the connection structure away from the via-hole; and the plurality of first compensation structures surround the via-hole. The first compensation structure is electrically connected to the first touch electrode block at the periphery of the via-hole.

In a possible implementation mode, the touch structure layer further includes: an anti-static structure; and the anti-static structure is disposed at one side, facing the via-hole, of the second touch pattern.

In a possible implementation mode, the shielding structure includes: at least one of the connection structure, the first compensation structure, or the anti-static structure.

In a possible implementation mode, the first touch electrode block and the second touch electrode block are disposed in a same layer; and the second touch pattern and the first touch electrode block are in the same layer and have a same material.

In a possible implementation mode, the touch structure layer further includes: a second compensation structure. The second compensation structure is disposed on one side of the second touch pattern close to the via-hole, and is electrically connected to the second touch pattern.

The embodiment of the present disclosure further provides a touch display device, including the touch display panel according to the embodiments of the present disclosure.

In a possible implementation mode, the touch display device further includes: a middle frame on a backlight side of the touch display panel, and a cover plate on a light-emitting side of the touch display panel.

In a possible implementation mode, a second light-shielding layer is further disposed on one side, facing the touch display panel, of the cover plate. An orthographic projection of the second light-shielding layer on the substrate surrounds the via-hole; and the orthographic projection of the second light-shielding layer on the substrate extends from the via-hole toward the display region, and covers at least part of the first region. The orthographic projection of the second light-shielding layer on the substrate has an overlapping region with the orthographic projection of the second touch pattern on the substrate.

### BRIEF DESCRIPTION OF FIGURES

FIG. 1A is a first schematic diagram of a touch unit.

FIG. 1B is a partially enlarged schematic view of FIG. 1A.

FIG. 2 is a schematic diagram of the principle of the display device in which a bright edge appears at a periphery of a via-hole.

FIG. 3A is a first schematic diagram of a partial top view of a touch display panel according to embodiments of the present disclosure.

FIG. 3B is a partially enlarged schematic view of FIG. 3A.

FIG. 4A is a first partially enlarged schematic view of a first touch pattern and a second touch pattern according to embodiments of the present disclosure.

FIG. 4B is a second partially enlarged schematic view of a first touch pattern and a second touch pattern according to embodiments of the present disclosure.

FIG. 4C is a third partially enlarged schematic view of a first touch pattern and a second touch pattern according to embodiments of the present disclosure.

FIG. 4D is a fourth partially enlarged schematic view of a first touch pattern and a second touch pattern according to embodiments of the present disclosure.

FIG. 5 is a first schematic diagram of a corresponding cross-section of FIG. 3A at aa′.

FIG. 6 is a second schematic diagram of a corresponding cross-section of FIG. 3A at aa′.

FIG. 7A is a third schematic diagram of a corresponding cross-section of FIG. 3A at aa′.

FIG. 7B is a schematic diagram of distribution of a first light-shielding layer and a second light-shielding layer at the location of a via-hole according to embodiments of the present disclosure.

FIG. 7C is an enlarged schematic view of the dashed box S3 in FIG. 7B.

FIG. 8A is a schematic diagram of a structure of a display device in a display region according to embodiments of the present disclosure.

FIG. 8B is an enlarged schematic view of a display structure layer X in FIG. 8A.

FIG. 8C is an enlarged schematic view of a display structure layer at a periphery of a via-hole K.

FIG. 9A is a second schematic diagram of a partial top view of a touch display panel according to embodiments of the present disclosure.

FIG. 9B is a partially enlarged schematic view of FIG. 9A.

FIG. 10A is a third schematic diagram of a partial top view of a touch display panel according to embodiments of the present disclosure.

FIG. 10B is a partially enlarged schematic view of FIG. 10A.

FIG. 11A is a fourth schematic diagram of a partial top view of a touch display panel according to embodiments of the present disclosure.

FIG. 11B is a partially enlarged schematic view of FIG. 11A.

FIG. 12A is a fifth schematic diagram of a partial top view of a touch display panel according to embodiments of the present disclosure.

FIG. 12B is a partially enlarged schematic view of FIG. 12A.

FIG. 13A is a sixth schematic diagram of a partial top view of a touch display panel according to embodiments of the present disclosure.

FIG. 13B is a partially enlarged schematic view of FIG. 13A.

### DETAILED DESCRIPTION

In order to make objectives, technical solutions and advantages of embodiments of the present disclosure clearer, technical solutions of embodiments of the present disclosure will be described clearly and completely in the following in conjunction with accompanying drawings of embodiments of the present disclosure. Obviously, the described embodiments are a part of the embodiments of the present disclosure and not all of the embodiments. Based on the described embodiments of the present disclosure, all other embodiments obtained by a person of ordinary skill in the art without creative labor fall within the scope of protection of the present disclosure.

Unless otherwise defined, technical or scientific terms used in the present disclosure shall have the ordinary meaning understood by a person of ordinary skill in the field to which the present disclosure belongs. The words “first”, “second”, and the like as used in the present disclosure do not indicate any order, number, or significance, but are only used to distinguish different components. The words “including” or “comprising” and the like are intended to mean that the element or object appearing before the word contains the elements or objects listed after the word and their equivalents, without excluding other elements or objects. The words such as “connected” or “coupled” are not limited to physical or mechanical connections, but may include electrical connections, whether direct or indirect. The words “up”, “down”, “left”, “right”, etc., are used only to indicate relative positional relationships. When the absolute position of the described object is changed, the relative positional relationship may be changed accordingly.

In order to keep the following description of embodiments of the present disclosure clear and concise, the present disclosure omits detailed descriptions of known functions and known components.

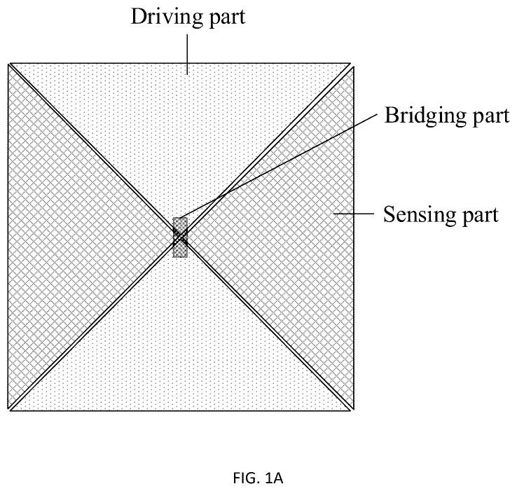

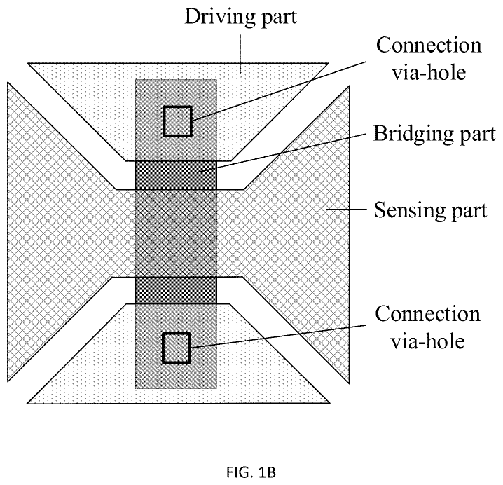

The touch display panel includes a plurality of touch units (Sensor), as shown in FIG. 1A and FIG. 1B. FIG. 1B is a partially enlarged schematic view of FIG. 1A. The touch unit is usually square, and is divided into a driving part, a sensing part, a bridging part, and connection via-holes according to functions. The driving part is two independent driving pattern blocks, and the sensing part is one sensing pattern block. The driving pattern blocks and the sensing pattern block are located in the same metal layer (e.g., TMB metal layer), and the bridging part is located in another metal layer (e.g., TMA metal layer). The connection via-holes are formed at both ends of the bridging part, for connecting the independent driving pattern blocks (of course, the bridging part can also be used for connecting the independent sensing pattern block). In the entire touch panel, a plurality of touch units are formed in an array, with the driving channel extending longitudinally, and the sensing channel extending laterally.

At the location of the via-hole in the display region, the touch unit is cut by the via-hole to become incomplete. A region between the display region and the cutting line (Cutting line, i.e., an outer edge of the via-hole) is designed with a large area of annular metal, including, for example, the TMB annular metal (the solid surface metal without a mesh hole, while the touch unit is metal mesh with mesh holes) made with a TMB metal layer near the display region, and the TMA annular metal made with a TMA metal layer away from the display region. One of the roles of the TMB annular metal and the TMA annular metal is to cover the gap between the display region and the second light-shielding layer (e.g., ink) of the cover plate to prevent the light leakage problem; and the second role is in connection, capacitance compensation, and static shielding, etc. In addition, the region between the cutting lines of the display region is usually provided with a dam structure. Since the region between the dam structure and the via-hole is not covered and filled by an organic layer, the segment difference between different locations is large. When the touch unit, the TMB annular metal, the TMA annular metal usually ends on one side of the dam structure away from the via-hole to avoid crossing one side of the dam structure facing the via-hole, the large segment difference is prone to the short-circuit problem. Due to the fact that the TMB annular metal is located in the same layer with the drive pattern block and the sensing pattern block in the touch unit, the touch unit can only be further end on the boundary of the display region and cannot be expanded outwards, and the touch performance is affected.

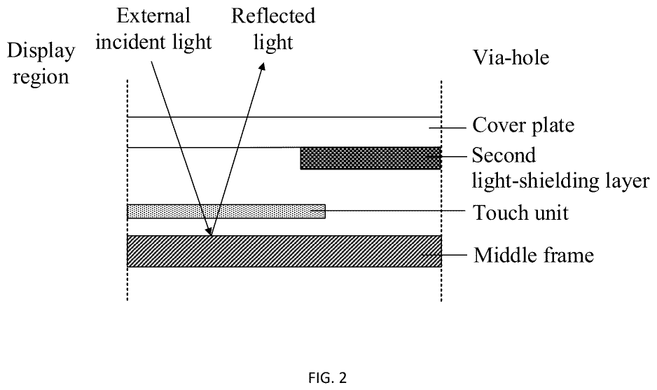

FIG. 2 shows a design with a high risk of light leakage. The touch unit is expanded outwards. Between the display region AA and the second light-shielding layer (such as ink) on the cover plate, there is no structure effectively shielding reflection from the middle frame in the lower part of the touch display panel. It's easy to observe bright edges around the periphery of the via-hole at a macro level, that is, light leakage problems, affecting the user experience.

In order to avoid light leakage at the peripheral position of the via-hole, the touch unit cannot be expanded outwards, and usually ends on the boundary of the display region (AA).

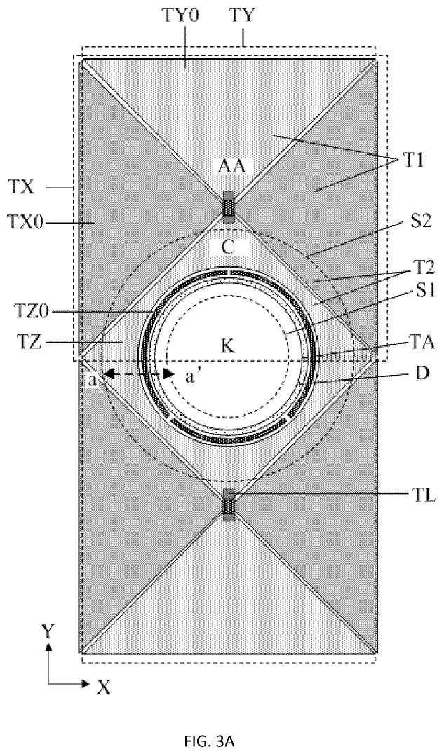

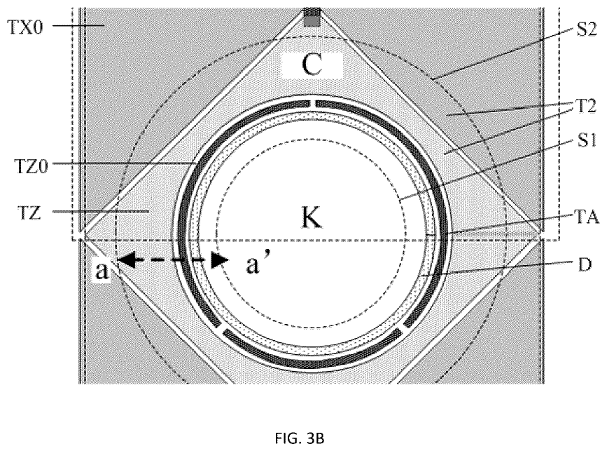

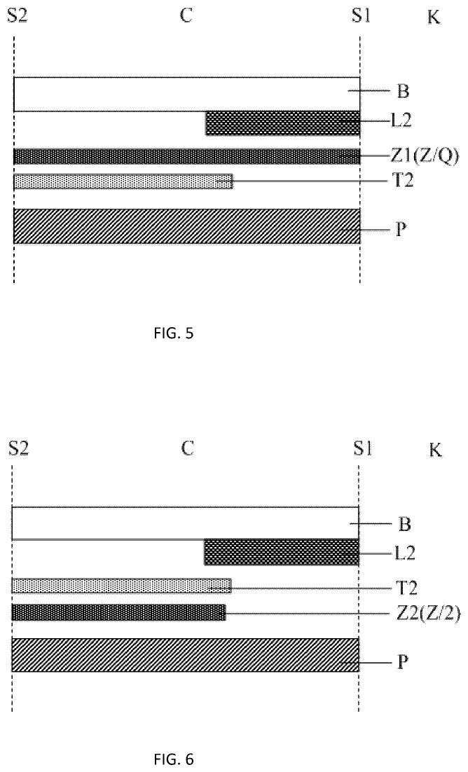

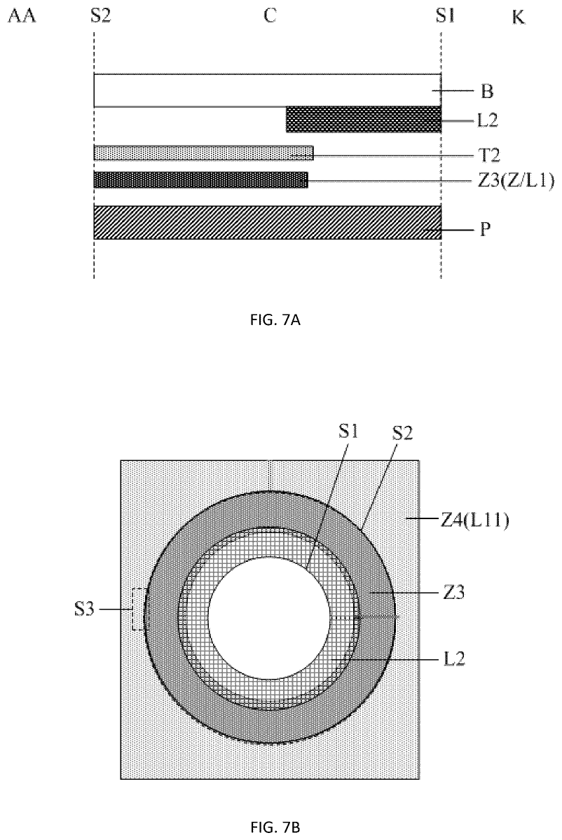

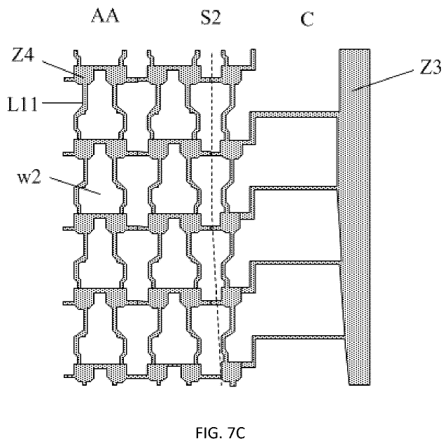

In view of this, embodiments of the present disclosure provide a touch display panel, as shown in FIG. 3A, FIG. 3B, FIG. 5, FIG. 6, and FIG. 7A. FIG. 3B is a partially enlarged schematic view of FIG. 3A, FIG. 5 is a first schematic diagram of a corresponding cross-section of FIG. 3A at aa′, FIG. 6 is a second schematic diagram of a corresponding cross-section of FIG. 3A at aa′, and FIG. 7A is a third schematic diagram of a corresponding cross-section of FIG. 3A at aa′. The touch display panel has a via-hole K penetrating through the touch display panel, a display region AA outside the via-hole K, and a first region C between the via-hole K and the display region AA. The touch display panel includes:
a substrate 1;
a shielding structure Z on one side of the substrate 1, located in the first region, and surrounding a periphery of the via-hole K; where an orthographic projection of the shielding structure Z on the substrate 1; and
a touch structure layer T, disposed on the same side of the substrate 1 as the shielding structure 2; where the touch structure layer T includes: a first touch pattern T1, and a second touch pattern T2; the first touch pattern T1 is disposed in the display region AA, and the second touch pattern T2 is disposed in the first region C; and the first touch pattern T1, and the second touch pattern T2 are both a mesh structure including a plurality of first openings w1.

In embodiments of the present disclosure, the touch display panel has a shielding structure Z. The shielding structure Z extends toward the via-hole K from the display region AA, and covers at least a portion of the first region C, which can realize light shielding of the first region C between the display region AA and the via-hole K. The touch structure T includes: the second touch pattern T2 in the first region C, that is, the touch structure layer T is not only distributed in the display region AA, but also extended outwards to the first region between the display region AA and the via-hole K, which can increase the touch area of the touch structure layer around the via-hole K, improve the touch performance, and improve the problems that the touch unit becomes incomplete due to being cut by the via-hole K, the pattern of the touch unit is missing and the touch performance is affected.

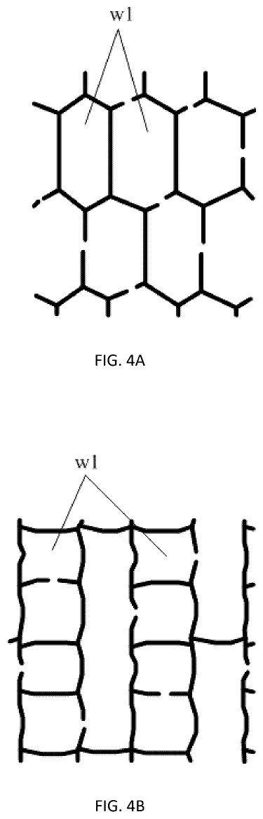

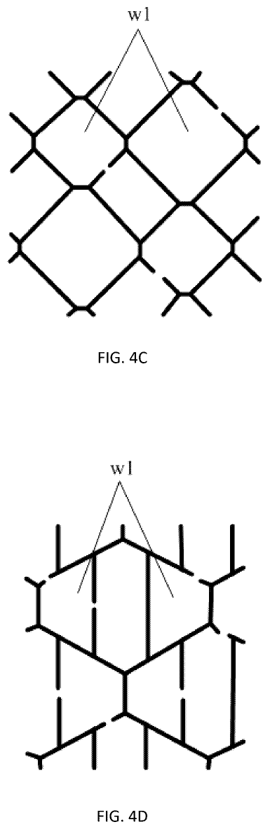

In a possible implementation mode, enlarged schematic views of the first touch pattern T1 and the second touch pattern T2 may be shown in FIGS. 4A-FIG. 4D, all of which may be a mesh structure including a plurality of first openings w1. As can be seen from the enlarged schematic views of the first touch pattern T1 and the second touch pattern T2, the first touch pattern T1 and the second touch pattern T2 have many mesh holes in themselves, which cannot be used for shielding light. Therefore, other structures are needed for shielding light in the region around the via-holes K.

In a possible implementation mode, see FIG. 5, the display panel further includes: a light-filtering structure layer Q. The light-filtering structure layer Q includes: a first shielding portion Z1, and the first shielding portion Z1 is located in the first region C. The shielding structure Z includes the first shielding portion Z1. In the embodiments of the present disclosure, the structure of the light-filtering structure layer can be utilized to achieve the light shielding of the first region C, to avoid light leakage at the periphery of the via-hole K. The touch structure layer can be extended outwards to the first region C, increasing the touch area of the touch structure layer at the periphery of the via-hole K, improving the touch performance, and improving the problems that the touch unit becomes incomplete due to being cut by the via-hole K, the pattern of the touch unit is missing, and the touch performance is affected.

In a possible implementation mode, see FIG. 5, the light-filtering structure layer Q is disposed on one side, facing away from the substrate 1, of the touch structure layer T.

In a possible implementation mode, referring to FIG. 6, the touch display panel further includes: a pixel defining layer 2. The pixel defining layer 2 includes: a second shielding portion Z2, and the second shielding portion Z2 is disposed in the first region C. The shielding structure Z includes the second shielding portion Z2. In the embodiments of the present disclosure, the display panel further includes: a pixel defining layer 2; the pixel defining layer 2 includes: a second shielding portion Z2 in the first region C; and the shielding structure Z includes the second shielding portion Z2. The pixel defining layer 2 can be utilized to achieve light shielding of the first region C, to avoid light leakage at the periphery of the via-hole K. The touch structure layer can be expanded outwards to the first region C, increasing the touch area of the touch structure layer at the periphery of the via-hole K, improving the touch performance, and improving the problems that the touch unit becomes incomplete due to being cut by the via-hole K, the pattern of the touch unit is missing, and the touch performance is affected.

In a possible implementation mode, see FIG. 7A-FIG. 7C, FIG. 7B is a schematic diagram of distribution of a first light-shielding layer and a second light-shielding layer at the location of the via-hole according to embodiments of the present disclosure, and FIG. 7C is an enlarged schematic view of the dashed box S3 in FIG. 7B. The touch display panel further includes: an active layer 3 between the substrate 1 and the touch structure layer T, and a first light-shielding layer L1 between the active layer 3 and the substrate 1. The first light-shielding layer L1 includes: a plurality of third light-shielding portions Z3 in the display region AA, and a third shielding portion Z3 in the first region C. The shielding structure Z includes the third shielding portion Z3.

In embodiments of the present disclosure, the display panel further includes a first light-shielding layer L1; the first light-shielding layer L1 includes: a third light-shielding portion Z3 in the first region C; and the shielding structure Z includes a third light-shielding portion Z3. The third light-shielding portion Z3 can be utilized to achieve the light shielding of the first region C, to avoid light leakage at the periphery of the via-hole K. The touch structure layer can be expanded outwards to the first region C, increasing the touch area of the touch structure layer at the periphery of the via-hole K, improving the touch performance, and improving the problems that the touch unit becomes incomplete due to being cut by the via-hole K, the pattern of the touch unit is missing and the touch performance is affected.

In a possible implementation mode, shown in conjunction with FIG. 5, FIG. 6 and FIG. 7A, a cover plate B may be provided on a light-emitting side of the touch display panel; and a second light-shielding layer L2 may be provided on a side, facing the touch display panel, of the cover plate B. The shielding structure Z extends from the display region AA to the side of the via-hole K, and the second light-shielding layer L2 extends from the via-hole K to the side of the display region AA. The orthographic projection of the shielding structure Z may overlap with the orthographic projection of the second light-shielding layer L2. The sum of the orthographic projection of the shielding structure Z and the orthographic projection of the second light-shielding layer L2 can cover the entire first region C, thereby realizing total light shielding of the region between the display region AA and the via-hole K, and avoiding that if the shielding structure Z is not provided and when the external ambient light passes through the position in the first region C that is not shielded by the second light-shielding layer L2, the incident light will be incident to the middle frame of the backlight side of the touch display panel and reflected by the middle frame, which causes a problem of a bright edge at the periphery of the via-hole K.

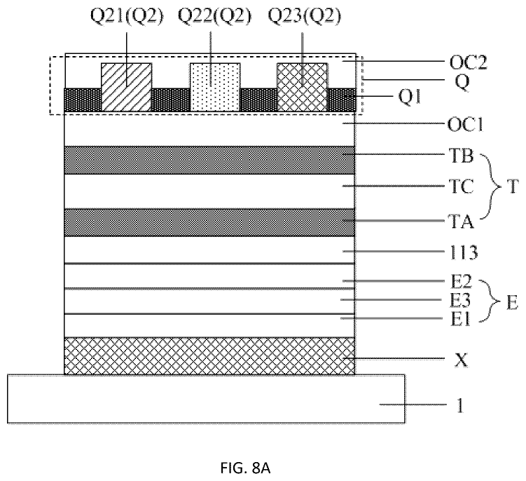

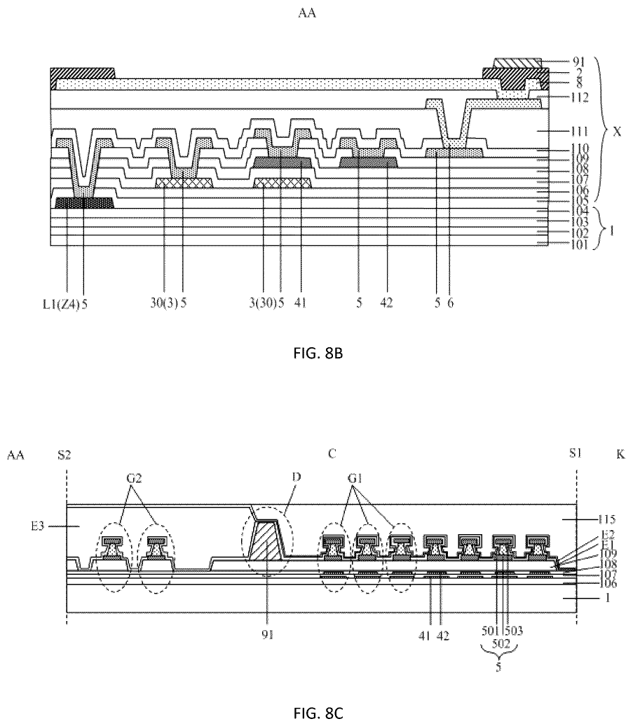

It is to be noted that FIGS. 5-6 and 7A are illustrations of a portion of the structure of the display device only for the purpose of clearly illustrating the light-shielding process of the shielding structure Z. However, embodiments of the present disclosure are not limited thereto. In a possible implementation mode, see FIG. 8A, FIG. 8B and FIG. 8C, FIG. 8A may be a schematic diagram of a structure of a display device in a display region according to embodiments of the present disclosure, FIG. 8B may be an enlarged schematic view of a display structure layer X in FIG. 8A, and FIG. 8C may be an enlarged schematic view of a display structure layer at the periphery of the via-hole K. In combination with FIG. 7C, FIG. 8A, FIG. 8B and FIG. 8C, the active layer 3 includes a plurality of active portions 30 in the display region AA; and the first light-shielding layer L1 includes: a plurality of fourth light-shielding portions Z4 in the display region AA; where an orthographic projection of the fourth light-shielding portion Z4 on the substrate 1 covers an orthographic projection of the active portion 30 on the substrate 1.

In a possible implementation mode, in conjunction with FIG. 7C, the first light-shielding layer L1 further includes: a plurality of connection structures L11 in the display region AA. The plurality of third shielding portions Z3 are electrically connected via the plurality of connection structures L11; and the plurality of third shielding portions Z3 and the plurality of connection structures L11 form a mesh structure having a plurality of second openings w2.

In a possible implementation mode, in conjunction with FIG. 7C, the third light-shielding portion Z3 is an integrated planar structure surrounding the via-hole K. That is, the third light-shielding portion Z3 is a solid planar metal structure without mesh holes, unlike the composition of the first light-shielding layer L1 in the display region AA.

In a possible implementation mode, in conjunction with FIG. 8A, FIG. 8B and FIG. 8C, the display device may include an encapsulation layer E disposed on one side of the display structure layer X facing away from the substrate 1, a touch structure layer T disposed on one side of the encapsulation layer E facing away from the display structure layer, and a color-filtering structure layer Q disposed on one side of the touch structure layer T facing away from the encapsulation layer E. The color-filtering structure layer Q may include a black matrix layer Q1, and a color film layer Q2. The color-filtering structure layer Q can replace a conventional polarizer to avoid the problem of reflection caused by the external ambient light and natural light irradiating the display panel, which affects the display effect. Moreover, compared to attaching a polarizer alone, integrating the color-filtering structure layer Q in the touch display panel can improve the contrast and brightness of the touch display panel, and reduce the thickness and the power consumption of the touch display panel, etc. In the embodiments of the present disclosure, on this basis, the first shielding portion Z1 is further made by the black matrix layer Q1 in the color-filtering structure layer Q, which can simultaneously avoid light leakage of the touch display device at the periphery of the via-hole K, further expand the pattern of the touch unit outwards, and improve the touch performance.

In a possible implementation mode, in conjunction with FIG. 8A, FIG. 8B and FIG. 8C, the display structure layer X may include: a first gate metal layer 41 located on one side of the active layer 3 facing away from the substrate 1, a second gate metal layer 42 located on one side of the first gate layer 41 facing away from the substrate 1, a first source-drain layer 5 located on one side of the second gate metal layer 42 facing away from the substrate 1, a second source-drain layer 6 located on one side of the first source-drain layer 5 facing away from the substrate 1, an anode layer 8 located on one side of the second source-drain layer 6 facing away from the substrate 1, a pixel defining layer 2 located on one side of the anode layer 8 facing away from the substrate 1, and a spacer 91 located on one side of the pixel defining layer facing away from the substrate 1. In a possible implementation mode, the pixel defining layer 2 may be a black opaque material, and the pixel defining layer 2 may include a second shielding portion Z2, that is, the pixel defining layer 2 is used for making the shielding structure Z, avoiding light leakage of the touch display device at the periphery of the via-hole K, further outwards expanding the pattern of the touch unit, improving the touch performance, and avoiding the increase in the fabrication process of the touch display panel and the increase in the fabrication cost of the touch display panel when the shielding structure Z is provided separately.

In a possible implementation mode, combined with FIG. 8A, FIG. 8B and FIG. 8C, the substrate 1 may include a composite structure with multiple film layers stacked. For example, the substrate 1 may include: a first organic layer 101, a first inorganic layer 102, a second organic layer 103 and a second inorganic layer 104 which are sequentially stacked. The material of the first organic layer 101 and the second organic layer 103 may include polyimide. A first blocking layer 105 and a first buffer layer 106 may be provided between the first light-shielding layer L1 and the active layer 3. A first gate insulating layer 107 may be provided between the active layer 3 and the first gate metal layer 41. A second gate insulating layer 108 may be provided between the second gate metal layer 42 and the first gate metal layer 41. An interlayer dielectric layer 109 may be provided between the second gate metal layer 42 and the first source-drain layer 5. A passivation layer 110 and a first planarization layer 111 are provided between the first source-drain layer 5 and the second source-drain layer 6. A second planarization layer 112 is provided between the second source-drain layer 6 and the anode layer 8. A second buffer layer 113 is provided between the encapsulation layer E and the touch structure layer T. A first optical adhesive layer OC1 is provided between the touch structure layer T and the color-filtering structure layer Q. A second optical adhesive layer OC2 is provided on one side of the color-filtering structure layer Q facing away from the touch structure layer T.

In a possible implementation mode, in conjunction with FIG. 8A and FIG. 8C, the encapsulation layer E may be a thin-film encapsulation layer, and specifically may include a first inorganic encapsulation layer E1, an organic encapsulation layer E3, and a second inorganic encapsulation layer E2 which are stacked.

In a possible implementation mode, in conjunction with FIG. 8C, the touch display panel further includes: a dam structure D and a first isolation structure G1 between the substrate 1 and the touch structure layer T. The dam structure D is located in the first region C and surrounds the via-hole K. The first isolation structure G1 is located between the dam structure D and the via-hole K and surrounds the via-hole K. In conjunction with FIG. 3A, FIG. 3B and FIG. 8C, an orthographic projection of the second touch pattern T2 on the substrate 1 is located at one side, facing away from the via-hole K, of an orthographic projection of the dam structure D on the substrate 1. In embodiments of the present disclosure, as shown in FIG. 3A, the second touch pattern T2 may terminate at the dam structure D, i.e., the dam structure D does not enter the region between the dam structure D and the via-hole K, to avoid a short circuit problem of the second touch pattern T2 caused by the first isolation structure G1 between the dam structure D and the via-hole K.

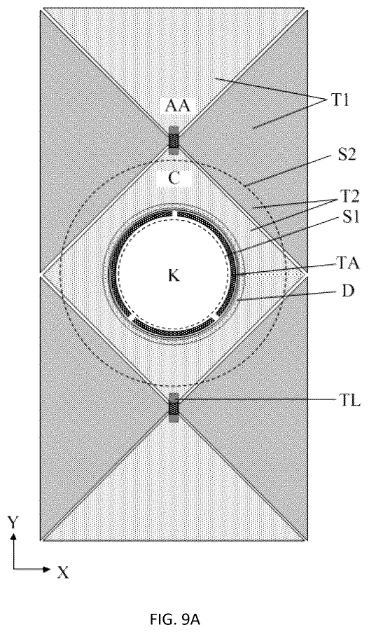

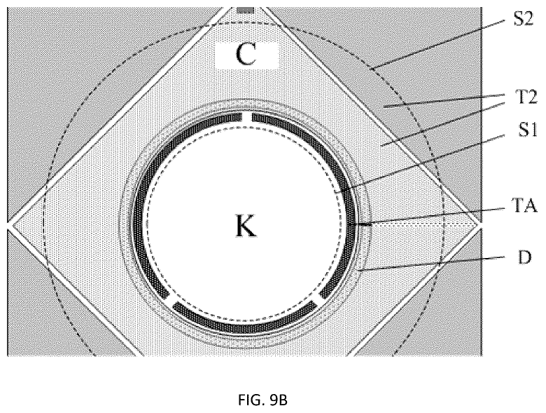

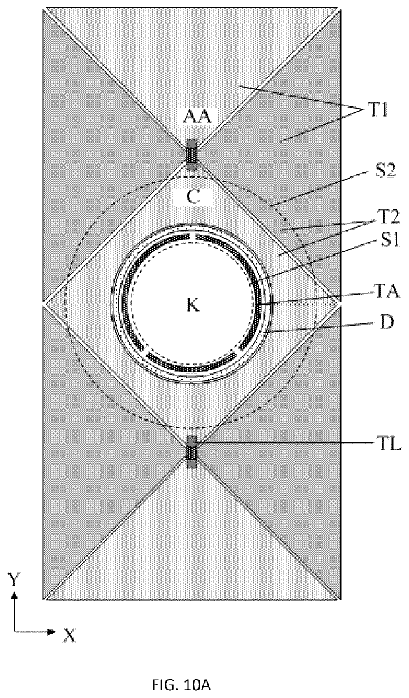

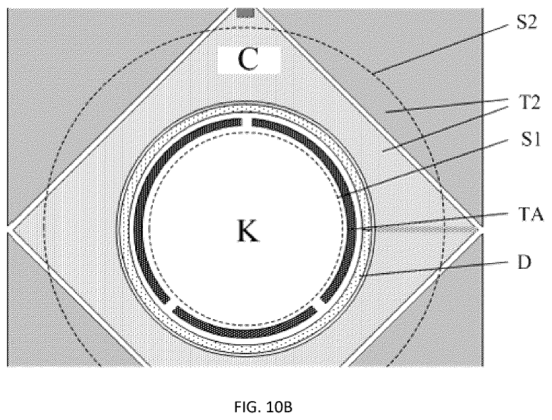

In a possible implementation mode, shown in conjunction with FIG. 8C, the touch display panel further includes: a dam structure D, a first isolation structure G1 and a first filling layer 115 covering at least the first isolation structure G1, between the substrate 1 and the touch structure layer T. The dam structure D is located in the first region C and surrounds the via-hole K. The first isolation structure G1 is located between the dam structure D and the via-hole K, and surrounds the via-hole K. As shown in conjunction with FIG. 9A and FIG. 9B which is a partially enlarged schematic view of FIG. 9A, an orthographic projection of the second touch pattern T2 on the substrate 1 covers orthographic projections of the dam structure D and at least a portion of the first isolation structure G1 on the substrate 1. In the embodiments of the present disclosure, the touch display panel further includes a first filling layer 115, and the first filling layer 115 may flatten the first isolation structure G1, so that the second touch pattern T2 may be further outwards expanded to cover the blocking wall structure D and at least a portion of the first isolation structure G1, which may further increase the touch area of the touch structure layer at the periphery of the via-hole K, increase the touch performance, and improve the problems that the touch unit becomes incomplete due to being cut by the via-hole K, the pattern of the touch unit is missing and the touch performance is affected.

In a possible implementation mode, shown in conjunction with FIG. 8B and FIG. 8C, the first isolation structure G1 may have the same composition as the second source-drain layer 6; and the first isolation structure G1 may specifically include a first metal layer 501, a second metal layer 502, and a third metal layer 503 which are stacked. The material of the first metal layer 501 may include titanium, the material of the second metal layer 502 may include aluminum, and the material of the third metal layer 503 may include aluminum.

In a possible implementation mode, shown in conjunction with FIG. 8A, FIG. 8B and FIG. 8C, the touch display panel may further include a second dam structure G2 located on one side of the dam structure D facing away from the via-hole K. The second dam structure G2 may have the same composition as the first dam structure G1.

In a possible implementation mode, shown in conjunction with FIG. 3A or FIG. 9A, the touch structure layer T further includes: an anti-static structure TA; and an orthographic projection of the second touch pattern T2 on the substrate 1 is located at one side, facing away from the via-hole K, of an orthographic projection of the anti-static structure TA on the substrate 1. In the embodiments of the present disclosure, the touch display structure layer T also includes the anti-static structure TA, which can play the role of electrostatic shielding to avoid damage to the structure of the touch structure layer due to electrostatic action. Moreover, the orthographic projection of the second touch pattern T2 on the substrate 1 is located at the side, facing away from the via-hole K, of the orthographic projection of the anti-static structure TA on the substrate 1, avoiding an electrical connection between the first touch pattern T1 and/or the second touch pattern T2 to the anti-static structure TA.

In a possible implementation mode, shown in conjunction with FIG. 3A, an orthographic projection of the anti-static structure TA on the substrate 1 is located at one side, facing away from the via-hole K, of an orthographic projection of the dam structure D on the substrate 1.

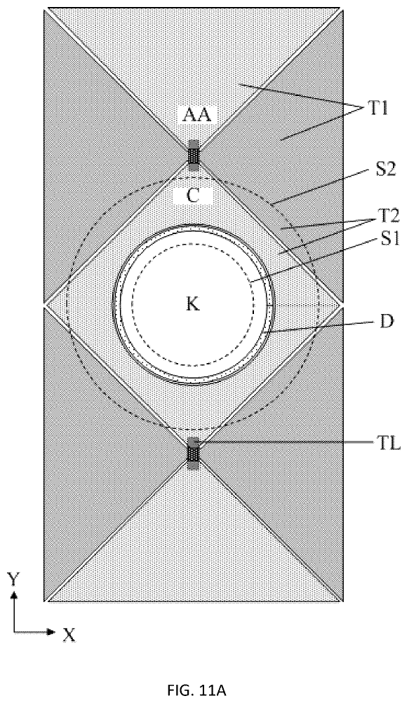

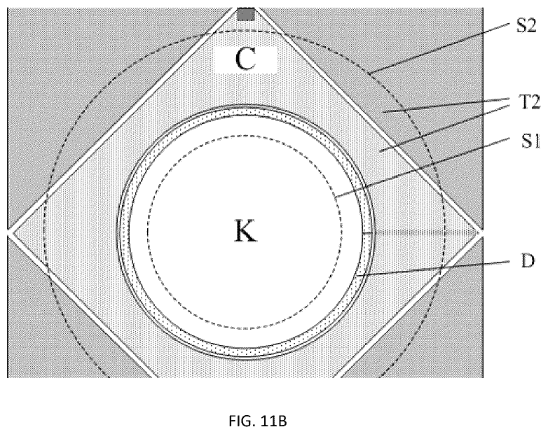

In a possible implementation mode, shown in conjunction with FIG. 10A and FIG. 10B which is a partially enlarged schematic view of FIG. 10A, an orthographic projection of the anti-static structure TA on the substrate 1 is located at one side, close to the via-hole K, of an orthographic projection of the dam structure D on the substrate 1. In embodiments of the present disclosure, an orthographic projection of the anti-static structure TA on the substrate 1 is located at one side, close to the via-hole K, of an orthographic projection of the dam structure D on the substrate 1. That is, the anti-static structure TA is moved to the region between the dam structure D and the via-hole K, and the second touch pattern T2 can be further expanded outwards, which can further increase the touch area of the touch structure layer at the periphery of the via-hole K, improve the touch performance, and improve the problems that the touch unit becomes incomplete due to being cut by the via-hole K, the pattern of the touch unit is missing, and the touch performance is affected.

In a possible implementation mode, shown in conjunction with FIG. 11A and FIG. 11B which is a partially enlarged schematic view of FIG. 11A, the anti-static structure TA may also be canceled, so that the second touch pattern T2 may be further expanded outwards, which may further increase the touch area of the touch structure layer at the periphery of the via-hole K, increase the touch performance, and improve the problems that the touch unit becomes incomplete due to being cut by the via-hole K, the pattern of the touch unit is missing, and the touch performance is affected.

In a possible implementation mode, shown in conjunction with FIG. 3A, FIG. 9A, and FIG. 10A, the anti-static structure TA includes: a plurality of arc segments spaced apart from each other and surrounding the via-hole.

In a possible implementation mode, shown in conjunction with FIG. 3A, the touch structure layer T includes: a plurality of first touch electrodes TX extending along a first direction X, and a plurality of second touch electrodes TY extending along a second direction Y. The first touch electrode TX includes a plurality of first touch electrode blocks TX0 sequentially arranged along the first direction X and electrically connected, and the second touch electrode TY includes a plurality of second touch electrodes blocks TY0 sequentially arranged along the second direction Y and electrically connected. One of the first touch electrode block TX0 and the second touch electrode block TY0 includes a third touch electrode block TZ, and the via-hole K is located in the third touch electrode block TZ. The third touch electrode block TZ includes a second touch pattern 32.

In a possible implementation mode, shown in conjunction with FIG. 3A, the third touch electrode block TZ has a first hollow portion TZ0; and an orthographic projection of the first hollow portion TZ0 on the substrate 1 covers an orthographic projection of the via-hole K on the substrate 1.

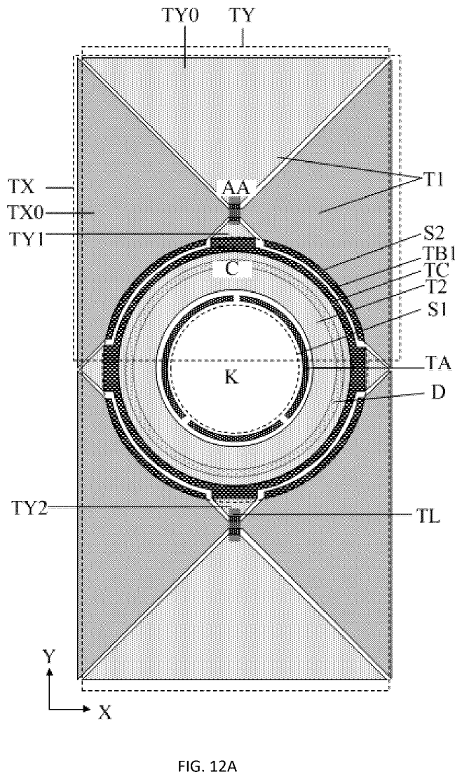

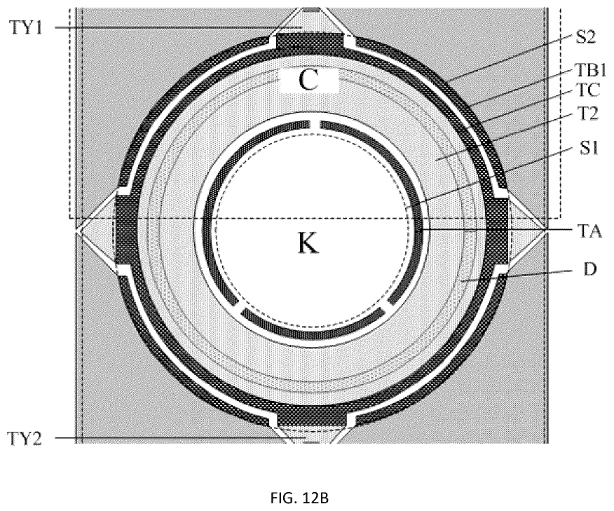

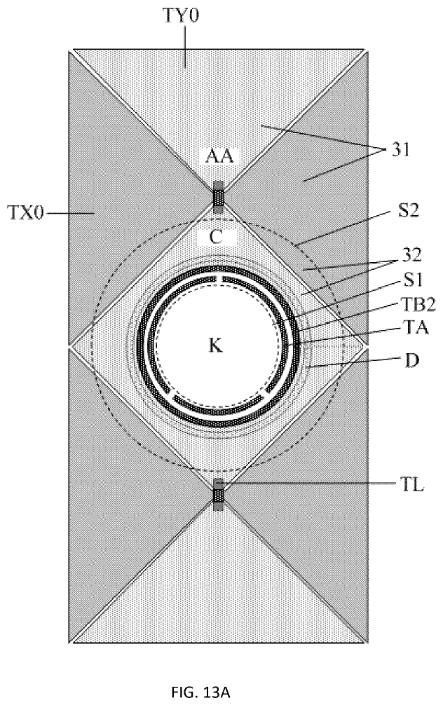

In a possible implementation mode, shown in conjunction with FIG. 12A and FIG. 12B which is a partially enlarged schematic view of FIG. 12A, the touch structure layer T includes: a plurality of first touch electrodes TX extending along a first direction X, and a plurality of second touch electrodes TY extending along a second direction Y. The first touch electrode TX includes a plurality of first touch electrode blocks TX0 sequentially arranged along the first direction X and electrically connected, and the second touch electrode TY includes a plurality of second touch electrode blocks TY0 sequentially arranged along the second direction Y and electrically connected. The at least one second touch electrode TY is divided by the via-hole K into a first sub-touch electrode TY1 and a second sub-touch electrode TY2 which are discontinuous.

The touch structure layer further includes: a connection structure TC. The connection structure TC is located in the first region C, surrounds the via-hole K, and is electrically connected to the first sub-touch electrodes TY1 and the second sub-touch electrodes TY2 on both sides of the via-hole K.

The second touch pattern T2 is located on one side of the connection structure close to the via-hole K, and is electrically connected to the connection structure TC.

In the embodiments of the present disclosure, the touch structure layer also includes a connection structure TC; and the second touch pattern T2 is located on one side of the connection structure close to the via-hole K, and is electrically connected to the connection structure TC. The second touch pattern T2 is also expanded outwards in the region between the connection structure TC and the via-hole K, which increases the touch area of the touch structure layer at the periphery of the via-hole K, improves the touch performance, and improves the problems that the touch unit becomes incomplete due to being cut by the via-hole K, the pattern of the touch unit is missing, and the touch performance is affected.

In a possible implementation mode, the outward expansion of the second touch pattern T2 shown in FIG. 12A may be based on the filling and flattening of the first isolation structure G1 between the dam structure D and the via-hole K shown in 8C, which realizes the outward expansion of the second touch pattern T2 while avoiding the short circuit of the second touch pattern T2 due to the unevenness of the first isolation structure G1.

In a possible implementation mode, shown in conjunction with FIG. 12A, the second touch pattern T2 is a ring shape that surrounds the via-hole K. That is, an outer contour of the second touch pattern T2 is a ring shape surrounding the via-hole K.

In a possible implementation mode, shown in conjunction with FIG. 12A, the touch structure layer T further includes: a plurality of first compensation structures TB1 located at one side of the connection structure TC away from the via-hole K; the plurality of first compensation structures TB1 surround the via-hole; and the first compensation structure TB1 is electrically connected to the first touch electrode block TX0 at a periphery of the via-hole K. In the embodiments of the present disclosure, the touch structure layer T further includes: a plurality of first compensation structures TB1 located at one side of the connection structure TC away from the side of the via-hole K, which can realize the supplementation of the first touch electrode block TX0 at the periphery of the via-hole K, to reduce the difference in pattern from the region of the non-via-hole K, and improve the touch performance at the periphery of the via-hole K.

In a possible implementation mode, shown in conjunction with FIG. 12A, the touch structure layer T further includes: an anti-static structure TA; and the anti-static structure TA is located at one side, facing the via-hole K, of the second touch pattern T2.

In a possible implementation mode, shown in conjunction with FIG. 12A, the shielding structure Z includes: at least one of a connection structure TC, a first compensation structure TB1, or an anti-static structure TA. In the embodiments of the present disclosure, at least one of the connection structure TC, the first compensation structure TB1 or the anti-static structure TA may be used as the shielding structure Z. The shielding of light at the peripheral position of the display region AA may also be realized while realizing to cause the second touch pattern T2 to be outwards expanded in the region between the connection structure TC and the via-hole K, and to increase the touch area of the touch structure layer at the periphery of the via-hole K.

In a possible implementation mode, the shielding structure Z includes: a connection structure TC, a first compensation structure TB1, and an anti-static structure TA.

In a possible implementation mode, the connection structure TC, the first compensation structure TB1 and the anti-static structure TA may be solid planar electrodes without mesh holes.

In a possible implementation mode, the first touch electrode block TX0 and the second touch electrode block TY0 are located in the same layer; and the second touch pattern T2 and the first touch electrode block TX0 are in the same layer and have the same material.

In a possible implementation mode, the connection structure TC, the first compensation structure TB1 and the first touch electrode block TX0 may be located in the same layer and have the same material; and the anti-static structure TA may be located in a different layer from the first touch electrode block TX0.

In a possible implementation mode, see FIG. 12A, the touch structure layer further includes: a bridging part TL; and in the region where the non-via-hole K is located, two adjacent second touch electrode blocks TY0 can be electrically connected via the bridging part TL. The bridging part TL can be located in a different layer from the second touch electrode block TY0, and specifically can be located between the second touch electrode block TY0 and the substrate 1. The bridging part TL can be electrically connected to the different second touch electrode blocks TY0 via punched holes. Specifically, the anti-static structure TA and the bridging part TL may be in the same layer and have the same material.

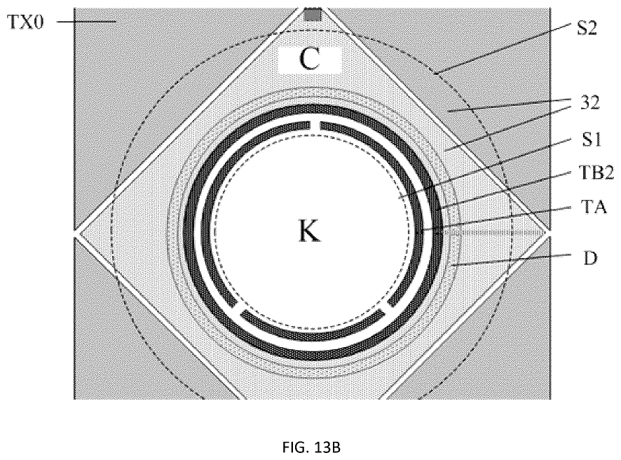

In a possible implementation mode, see FIG. 13A and FIG. 13B which is a partially enlarged schematic view of FIG. 13A, the touch structure layer T further includes: a second compensation structure TB2; and the second compensation structure TB2 is located on one side of the second touch pattern T2 close to the via-hole K, and is electrically connected to the second touch pattern T2. In the embodiments of the present disclosure, the touch structure layer T further includes: the second compensation structure TB2, to realize the supplementation of the second touch electrode block TY0 at the periphery of the via-hole K, reduce the difference in pattern from the region of the non-via-hole K, and improve the touch performance at the periphery of the via-hole K.

It is to be noted that the embodiments of the present disclosure only illustrate an example of the touch structure layer T also including the second compensation structure TB by taking the positional relationship between the dam structure D and the anti-static structure TA shown in FIG. 13A as an example. When the dam structure D and the anti-static structure TA are other positional relationships, the touch structure layer T may also include the second compensation structure TB, and the embodiments of the present disclosure are not limited thereto.

Based on the same inventive concept, the embodiments of the present disclosure also provide a touch display device, including the touch display panel according to the embodiments of the present disclosure.

In a possible implementation mode, see FIGS. 5, 6, and 7A, the touch display device further includes: a middle frame P located on a backlight side of the touch display panel, and a cover plate B located on a light-emitting side of the touch display panel.

In a possible implementation mode, a second light-shielding layer L2 is further provided on one side, facing the touch display panel, of the cover plate B. An orthographic projection of the second light-shielding layer L2 on the substrate 1 surrounds the via-hole K; and the orthographic projection of the second light-shielding layer L2 on the substrate 1 extends from the via-hole K toward the display region AA, and covers at least part of the first region C. The orthographic projection of the second light-shielding layer L2 on the substrate 1 has an overlapping region with the orthographic projection of the second touch pattern T2 on the substrate Z. Specifically, the orthographic projection of the second light-shielding layer L2 on the substrate 1 has an overlapping region with the orthographic projection of the shielding structure Z on the substrate z.

Although preferred embodiments of the present disclosure have been described, those skilled in the art may make additional changes and modifications to these embodiments once the basic inventive concepts are known. Therefore, the appended claims are intended to be construed to include the preferred embodiments as well as all changes and modifications that fall within the scope of the present disclosure.

Obviously, a person skilled in the art may make various modifications and variations to the embodiments of the present disclosure without departing from the spirit and scope of the embodiments of the present disclosure. Thus, if these modifications and variations of the embodiments of the present disclosure fall within the scope of the claims of the present disclosure and their technical equivalents, the present disclosure is intended to encompass these modifications and variations.

1-24. (canceled)

25. A touch display panel, having a via-hole penetrating through the touch display panel, a display region outside the via-hole, and a first region between the via-hole and the display region; wherein the touch display panel comprises:
a substrate;
a shielding structure on one side of the substrate, located in the first region and surrounding the via-hole; and
a touch structure layer on a same side of the substrate as the shielding structure; wherein the touch structure layer comprises: a first touch pattern and a second touch pattern; wherein the first touch pattern is disposed in the display region, and the second touch pattern is disposed in the first region; wherein the first touch pattern and the second touch pattern are both a mesh structure comprising a plurality of first openings.

26. The touch display panel according to claim 25, wherein the display panel further comprises: a light-filtering structure layer;
wherein the light-filtering structure layer comprises: a first shielding portion in the first region;
wherein the shielding structure comprises the first shielding portion;
wherein the light-filtering structure layer is disposed on one side, facing away from the substrate, of the touch structure layer.

27. The touch display panel according to claim 25, wherein the touch display panel further comprises: a pixel defining layer;
wherein the pixel defining layer comprises: a second shielding portion in the first region;
wherein the shielding structure comprises the second shielding portion.

28. The touch display panel according to claim 25, wherein the touch display panel further comprises: an active layer between the substrate and the touch structure layer, and a first light-shielding layer between the active layer and the substrate;
wherein the first light-shielding layer comprises: a third shielding portion in the first region; and the shielding structure comprises the third shielding portion.

29. The touch display panel according to claim 28, wherein the active layer comprises a plurality of active portions in the display region;
wherein the first light-shielding layer comprises: a plurality of fourth shielding portions in the display region;
wherein an orthographic projection of the fourth shielding portion on the substrate covers an orthographic projection of the active portion on the substrate.

30. The touch display panel according to claim 29, wherein the first light-shielding layer further comprises: a plurality of connection structures in the display region;
wherein the plurality of fourth shielding portions are electrically connected through the plurality of connection structures;
wherein the plurality of fourth shielding portions, and the plurality of connection structures form a mesh structure having a plurality of second openings.

31. The touch display panel according to claim 25, wherein the touch display panel further comprises: a dam structure and a first isolation structure, between the substrate and the touch structure layer;
wherein the dam structure is disposed in the first region and surrounds the via-hole; and the first isolation structure is disposed between the dam structure and the via-hole and surrounds the via-hole;
wherein an orthographic projection of the second touch pattern on the substrate is at one side, facing away from the via-hole, of an orthographic projection of the dam structure on the substrate.

32. The touch display panel according to claim 25, wherein the touch display panel further comprises: a dam structure, a first isolation structure and a first filling layer covering at least the first isolation structure, between the substrate and the touch structure layer;
wherein the dam structure is disposed in the first region and surrounds the via-hole; and the first isolation structure is disposed between the dam structure and the via-hole, and surrounds the via-hole;
wherein an orthographic projection of the second touch pattern on the substrate covers orthographic projections of the dam structure and at least a portion of the first isolation structure on the substrate.

33. The touch display panel according to claim 25, wherein the touch structure layer further comprises: an anti-static structure;
wherein the orthographic projection of the second touch pattern on the substrate is at one side, facing away from the via-hole, of an orthographic projection of the anti-static structure on the substrate.

34. The touch display panel according to claim 33, wherein the orthographic projection of the anti-static structure is at one side, close to the via-hole, of an orthographic projection of a dam structure on the substrate.

35. The touch display panel according to claim 33, wherein the anti-static structure comprises: a plurality of arc segments spaced apart from each other and surrounding the via-hole.

36. The touch display panel according to claim 25, wherein the touch structure layer comprises: a plurality of first touch electrodes extending along a first direction, and a plurality of second touch electrodes extending along a second direction;
wherein the first touch electrode comprises a plurality of first touch electrode blocks sequentially arranged along the first direction and electrically connected, and the second touch electrode comprises a plurality of second touch electrode blocks sequentially arranged along the second direction and electrically connected;
wherein one of the first touch electrode block and the second touch electrode block comprises a third touch electrode block, and the via-hole is disposed in the third touch electrode block;
wherein the third touch electrode block comprises the second touch pattern;
wherein the third touch electrode block has a first hollow portion; and an orthographic projection of the first hollow portion on the substrate covers an orthographic projection of the via-hole on the substrate.

37. The touch display panel according to claim 25, wherein the touch structure layer comprises: a plurality of first touch electrodes extending in a first direction, and a plurality of second touch electrodes extending in a second direction;
the first touch electrode comprises a plurality of first touch electrode blocks sequentially arranged along the first direction and electrically connected, and the second touch electrode comprises a plurality of second touch electrode blocks sequentially arranged along the second direction and electrically connected;
at least one of the plurality of second touch electrodes is divided by the via-hole into a first sub-touch electrode and a second sub-touch electrode which are discontinuous;
the touch structure layer further comprises: a connection structure; wherein the connection structure is disposed in the first region, surrounds the via-hole, and is electrically connected to the first sub-touch electrode and the second sub-touch electrode on both sides of the via-hole; and
the second touch pattern is disposed on one side of the connection structure close to the via-hole, and is electrically connected to the connection structure.

38. The touch display panel according to claim 37, wherein the second touch pattern is a ring shape surrounding the via-hole;
wherein the touch structure layer further comprises: a plurality of first compensation structures at one side of the connection structure away from the via-hole; and the plurality of first compensation structures surround the via-hole;
wherein the first compensation structure is electrically connected to the first touch electrode block at the periphery of the via-hole.

39. The touch display panel according to claim 37, wherein the touch structure layer further comprises: an anti-static structure; and the anti-static structure is disposed at one side, facing the via-hole, of the second touch pattern.

40. The touch display panel according to claim 37, wherein the shielding structure comprises: at least one of the connection structure, the first compensation structure, or the anti-static structure.

41. The touch display panel according to claim 36, wherein the first touch electrode block and the second touch electrode block are disposed in a same layer; and
the second touch pattern and the first touch electrode block are in the same layer and have a same material.

42. The touch display panel according to claim 25, wherein the touch structure layer further comprises: a second compensation structure;
wherein the second compensation structure is disposed on one side of the second touch pattern close to the via-hole, and is electrically connected to the second touch pattern.

43. A touch display device, comprising the touch display panel according to claim 25.

44. The touch display device according to claim 43, wherein the touch display device further comprises: a middle frame on a backlight side of the touch display panel, and a cover plate on a light-emitting side of the touch display panel;
wherein a second light-shielding layer is further disposed on one side, facing the touch display panel, of the cover plate;
wherein an orthographic projection of the second light-shielding layer on the substrate surrounds the via-hole; and the orthographic projection of the second light-shielding layer on the substrate extends from the via-hole toward the display region, and covers at least part of the first region;
wherein the orthographic projection of the second light-shielding layer on the substrate has an overlapping region with the orthographic projection of the second touch pattern on the substrate.
